(19) United States
(12) Patent Application Publication
(10) Pub. No.: US 2019/0390765 A1
(43) Pub. Date: Dec. 26, 2019

(54) DEVICE FOR DETECTING OPERATING STATES IN AN AUTOMATIC TRANSMISSION

(71) Applicant: WABCO GmbH, Hannover (DE)

(72) Inventors: Stefan GROETZINGER, Gehrden (DE); Michael JOHN, Lehrte (DE); Dirk MÜNTEFERING, Wedemark (DE)

(21) Appl. No.: 16/481,271

(22) PCT Filed: Mar. 6, 2018
(86) PCT No.: PCT/EP2018/055437

§ 371 Date: Jul. 26, 2019

(30) Foreign Application Priority Data
Mar. 16, 2017 (DE) 10 2017 002 540.1

(51) Int. Cl. F16H 59/68

(52) U.S. Cl. CPC F16H 59/68; F16H 59/72

(57) ABSTRACT

A device (1) for detecting operating states in a transmission has position sensors (4) for detecting the respective position of shiftable gear elements (6) and has a detector (10) for measuring the temperature in the transmission housing (2). In order to obtain sufficiently reliable and precise information about the temperature in the transmission housing (2), temperatures are measured at locations which are as different as possible in the transmission housing (2). For this purpose there is provision that at least one position sensor (4) has a sensor housing (3), in or at which a detector (10) for measuring the temperature is structurally integrated. In order to determine the temperature at different locations in the transmission housing (2), at least two such combined sensors (4) are used.

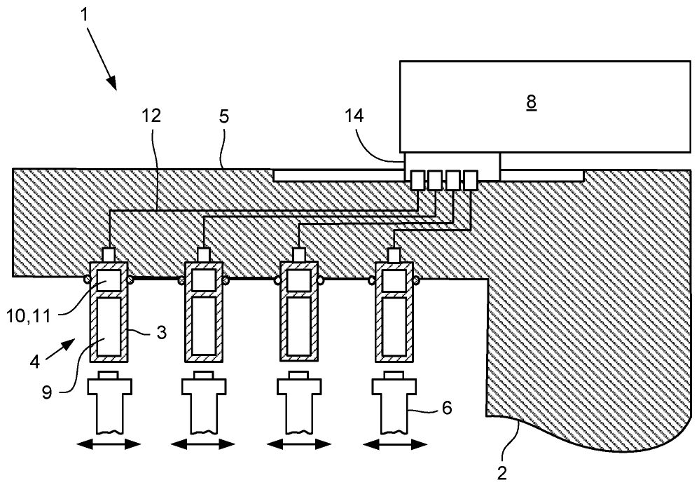

### TECHNICAL FIELD

The invention relates to a device for detecting operating states in a transmission, which device has position sensors for detecting the respective position of shiftable transmission elements and has a temperature detector for measuring the temperature in a transmission housing.

### BACKGROUND

For the safe operation and the control of the shifting sequences and selection sequences in an automatic transmission it is necessary to detect both the temperature of the oil in the transmission housing and the current position of the shiftable transmission elements, such as shift forks, in order to supply an electronic transmission control unit with the corresponding information. Devices for detecting these operating states conventionally use a number of position sensors which are assigned to the shiftable transmission elements, and a temperature sensor, wherein these sensors are connected in terms of signaling to gear control unit via respectively separate sensor lines and a central connecting plug.

It is disadvantageous here that in this way sufficiently reliable and precise information about the distribution of temperature in the transmission housing is not obtained, since said temperature distribution is measured only at one point which is not representative of the entire transmission. It is difficult to install a plurality of temperature sensors distributed over the transmission housing, with the associated cables, for reasons of the restricted installation space in the transmission housing and owing to additional blocking of the interface on the gear control unit; furthermore, said temperature sensor would additionally give rise to additional costs.

Against this background, the invention is based on the object of presenting a device of the above-mentioned type which, in addition to the abovementioned measurement of positions, also permits more reliable and precise detection of the temperature in the transmission housing at low cost and without the need for additional installation space.

### SUMMARY

The invention is based on the realization that a measurement of temperature is possibly essentially without additional installation space by using the position sensors which are arranged in the transmission housing in any case, and the respective sensor line of said position sensors.

Accordingly, the invention is based on a device for detecting operating states in a transmission, which device has position sensors for detecting the respective position of shiftable transmission elements and has a temperature detector for measuring the temperature in the transmission housing.

In order to achieve the stated object, with this device there is provision that a temperature detector for measuring the temperature is structurally integrated in or on the sensor housing of at least one position sensor.

In order to determine the temperature at different locations in the transmission housing, at least two such combined position sensors and temperature sensors are installed and utilized. In this way, a number of temperature measuring locations which correspond to the number of provided position sensors and their distribution over the interior of the transmission housing, and therefore more reliable and more precise temperature information, is obtained, wherein the individual temperatures can be evaluated in relation to the respective measuring location or can be utilized to form an average value. Since the temperature measuring function is structurally integrated in the position sensors, there is essentially no requirement for a greater installation space.

The integration of a temperature detector for measuring the temperature with a position sensor can be carried out in different ways. According to one first refinement of the invention there is provision that at least one of the position sensors is structurally integrated with a conventional temperature sensor element, for example, a known NTC (Negative Temperature Coefficient) element. Since temperature sensor elements have extremely small dimensions, they can be arranged in or at the housing of the position sensor easily and with low additional costs, without significantly changing the dimensions of said sensor.

Further, there is a possibility of using a position sensor with a directly integrated temperature sensor. A sensor which is integrated in such a way can be contained in the position measuring element itself or in a controller on an electronic circuit board of this sensor.

According to another refinement of the invention, at least one of the position sensors is configured for compensating the temperature. In this way, temperature information which can be evaluated is contained in the position sensor.

Furthermore, there is preferably provision that the respective sensor housing is connected to a central connecting plug via an assigned sensor line. In this way, both the position information and the temperature information can be respectively conducted via just one sensor line, so that excessive blocking of the interface with the electronic gear control unit can be avoided.

Position signals and temperature signals can be fed as two separate analog signals or digital signals to the electronic gear control unit via the sensor line which is assigned to an integrated position sensor.

Another way of transmitting the data provides that a digital output signal with combined information which contains position information and temperature information is conducted to the electronic gear control unit via the sensor line which is assigned to an integrated position sensor. An example of a suitable digital ion protocol could be, for example, a standard SENT (Single Edge Nibble Transmission) protocol or the like.

The invention can be explained further with reference to an exemplary embodiment. For this purpose, a drawing is appended to the description.

### BRIEF DESCRIPTION OF THE DRAWING

The single FIGURE of said drawing shows a schematic view of a device for detecting operating states in a transmission.

### DETAILED DESCRIPTION OF THE DRAWING

A device 1 for detecting operating states in a transmission has position sensors with integrated temperature sensors.

The FIGURE shows a transmission housing 2 with a transmission housing flange 5 on which, in the present example, four structurally identical combined position sensors 4 are arranged, of which only one will be described below by way of example. The position sensor 4 has the function of transmitting the shift position of the shiftable gear element 6, for example, a shift fork, which is assigned to said position sensor 4, and of transmitting said shift position to an electronic transmission control unit 8.

The position sensor 4 has a housing 3 in which, in addition to a position detector 9 for measuring the position, detector 10 for measuring the temperature, for example, a conventional temperature sensor element 11, are also structurally integrated. The position information of the position sensor 4 and the temperature information of the temperature sensor element 11 are conducted via a common sensor line 12 to a central connecting plug 14, from which said information can be passed on for evaluation to the electronic gear control unit 8.

As has already been stated, the integrated position sensors 4 which are illustrated in the FIGURE are structurally and functionally identical, such that they do not have to be described individually.

As has already been described above, the detector 10 for measuring the temperature can also be configured for compensating the temperature of the position sensor 4, so that the signal which is conducted via the sensor line 12 contains position information and temperature information which is evaluated in the electronic gear control unit.

### LIST OF REFERENCE NUMBERS (PART OF THE DESCRIPTION)

1 Device for detecting operating states

2 Transmission housing

3 Sensor housing

4 Position sensor

5 Transmission housing flange

6 Shiftable gear element, shift fork

8 Electronic gear control unit

9 Position detector

10 Temperature detector

11 Temperature sensor element

12 Sensor line

14 Central connecting plug

1. A device (1) for detecting operating states in a transmission, which device (1) has position sensors (4) for detecting the respective position of shiftable gear elements (6) and has at least one temperature detector (10) for measuring the temperature in the transmission housing (2), wherein at least one of the position sensors (4) has a sensor housing (3), with which one of the at least one temperature detector (10) for measuring the temperature is structurally integrated.

2. The device as claimed in claim 1, wherein the one of the at least one temperature detector is a temperature sensor element and the at least one position sensor (4) is structurally integrated with the temperature sensor element (11).

3. The device as claimed in claim 1 wherein the at least one position sensor (4) is configured for compensating the temperature.

4. The device as claimed in claim 1, wherein the sensor housing (3) is connected to a central connecting plug (14) via an assigned sensor line (12).

5. The device as claimed in claim 4, wherein the device is configured to transmit position signals and temperature signals as two separate analog signals or digital signals via the sensor line (12).

6. The device as claimed in claim 4, wherein the device is configured to transmit a digital output signal with combined information composed of position information and temperature information via the sensor line (12).
